(19) United States
(12) Patent Application Publication
(10) Pub. No.: US 2024/0037375 A1
(43) Pub. Date: Feb. 1, 2024

(54) Systems and Methods for Knowledge Distillation Using Artificial Intelligence

(71) Applicant: Northwestern University, Evanston, IL (US)

(72) Inventors: Dashun Wang, Evanston, IL (US); Nima Dehmamy, Chicago, IL (US); Lu Liu, Evanston, IL (US); Woo Seong Jo, Evanston, IL (US)

(21) Appl. No.: 18/265,513

(22) PCT Filed: Dec. 17, 2021
(86) PCT No.: PCT/US2021/063969

§ 371 Date: Jun. 6, 2023

Related U.S. Application Data
(60) Provisional application No. 63/127,511, filed on Dec. 18, 2020.

(51) Int. Cl. G06N 3/0455

(52) U.S. Cl. CPC G06N 3/0455

(57) ABSTRACT

An artificial intelligence (AI)-based knowledge distillation and paper production computing system processes instructions to use machine learning models to automatically review papers from a large corpus of papers and distill knowledge using science of science methods and AI-based modeling techniques. The AI-based knowledge distillation and paper production computing system processes instructions to leverage network science and machine learning tools to analyze papers with respect to a given topic to find relevant scientific publications, organize and group publications based on topic similarity and relation to the topic in general, and distill and summarize the message and content of these publications into a coherent set of statements.

### CROSS REFERENCE TO RELATED APPLICATION(S)

This application claims priority to Provisional Patent Application No. 63/127,511 entitled “SYSTEMS AND METHODS FOR KNOWLEDGE DISTILLATION USING ARTIFICIAL INTELLIGENCE” and filed on Dec. 18, 2020, which is incorporated by reference in its entirety.

### FIELD OF USE

Aspects of the disclosure relate generally to processing data and more specifically to classifying and summarizing data.

### BACKGROUND

A research paper typically includes original research results or reviews existing results. A research paper may undergo a series of reviews and/or revisions before being published. Once published, research papers can be read to gain a better understating of their subject matter and/or be used as background information for additional research.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems and methods in accordance with embodiments of the invention can use machine learning models to reviews papers from large corpus and distill knowledge using science of science methods and artificial intelligence. Network science and machine learning tools for a given topic can be used in order to find relevant scientific publications, organize and group publications based on topic similarity and relation to the topic in general, and distill and summarize the message and content of these publications into a coherent set of statements. This invention decreases the time required to conduct and publish scientific research and would increase the comprehensive review of similar scientific citations. This leads to reducing the burden of scientific knowledge creation and allow for more timely advances of science. This invention will also help with creating new course syllabi, presentation of literature review, finding and organizing patents needed or related to an idea, as well as distilling and reviewing legal cases relevant to a given case.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a processing system according to one or more aspects of the disclosure;

FIG. 2 shows an example computing device according to one or more aspects of the disclosure;

FIGS. 3A-3D show relationships between research papers of a corpus of research papers according to one or more aspects of the disclosure;

FIG. 4 illustrates an importance of use of a regularizing gradient boosting framework according to one or more aspects of the disclosure;

FIGS. 5 and 6 show clustering of research papers into sections according to one or more aspects of the disclosure;

FIG. 7 shows overlap between clusters found using a regularizing gradient boosting framework vs term frequency—inverse document frequency of keywords according to one or more aspects of the disclosure;

FIG. 8 shows a distribution of citations of references cited in sections according to one or more aspects of the disclosure;

FIG. 9 shows an illustrative modeling example according to one or more aspects of the disclosure;

FIG. 10 shows an illustrative survey according to one or more aspects of the disclosure; and

FIG. 11 shows survey results in accordance with one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure can be practiced. It is to be understood that other embodiments can be utilized and structural and functional modifications can be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein can relate to methods and techniques for automatically processing research papers. Given the vast amount of research articles in different areas of science and humanities, efficient retrieval and condensing of relevant information is crucial for our ability to utilize humanities knowledge. While search engines and data mining allow us to find candidate articles or publications in relation with to a query, casting the collected information in a coherent form, as humans do in presentations, review articles, or textbooks, has not been fully achieved yet.

Systems and methods in accordance with embodiments of the invention utilize a pipeline for creating review articles which combines science of science method with a transformer-based seq2seq architecture to create a complete review article. Machine learning models can be used to generate coherent summarization of multiple textual sources and can aide in scientific writing. This can have a great impact in reducing the burden of writing scientific articles and knowledge condensation, thus accelerating the advancement of science.

Systems and methods described herein produce a review paper automatically using a recommendation system for citations and transformers for text summarization and composition. In the first step, the system can suggest suitable papers to be cited in a review paper from the given single seed. We rely on science of science measures (detailed below) and co-citation patterns of a seed paper, which guarantees finding relevant potential references. Next, we use a BERT-based machine learning architecture fine-tuned on citation context to summarize the abstract of a paper to a sentence or two. To compose the paper into sections we perform a principal component analysis and k-means clustering on the list of references based on the contents of their abstracts. Within each section, we arrange the papers based on co-citations with the seed paper as well as other science of science measures

### Operating Environment and Computing Devices

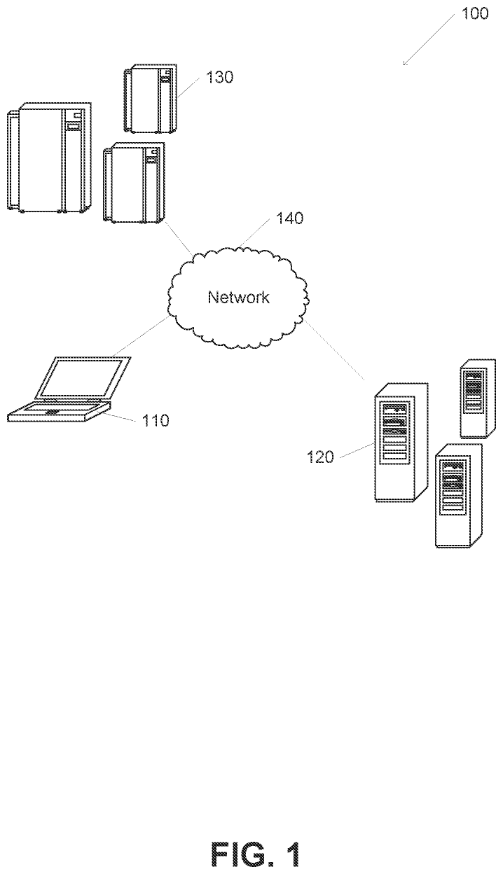

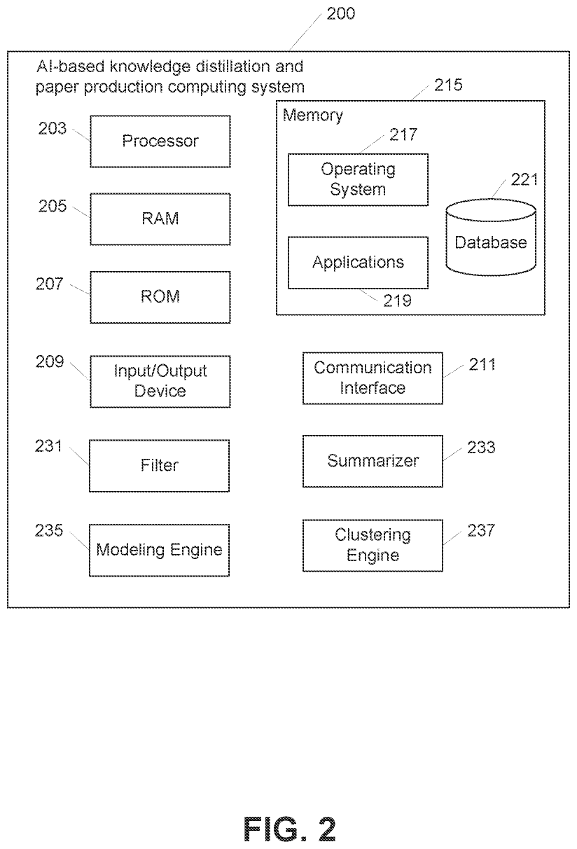

FIG. 1 shows an operating environment 100. The operating environment 100 can include at least one client device 110, at least one database system 120, and/or at least one server system 130 in communication via a network 140. The network 140 can include a local area network (LAN), a wide area network (WAN), a wireless telecommunications network, and/or any other communication network or combination thereof. It will be appreciated that the network connections shown are illustrative and any means of establishing a communications link between the computers can be used. The existence of any of various network protocols such as TCP/IP, Ethernet, FTP, HTTP and the like, and of various wireless communication technologies such as GSM, CDMA, WiFi, and LTE, is presumed, and the various computing devices described herein can be configured to communicate using any of these network protocols or technologies. Any of the devices and systems described herein can be implemented, in whole or in part, using one or more computing devices described with respect to FIG. 2.

Client devices 110 can obtain and/or process research papers as described herein. Database systems 120 can obtain, store, and provide a variety of research papers as described herein. Databases can include, but are not limited to relational databases, hierarchical databases, distributed databases, in-memory databases, flat file databases, XML databases, NoSQL databases, graph databases, and/or a combination thereof. Server systems 130 can obtain and/or process research papers as described herein.

The data transferred to and from various computing devices in the operating environment 100 can include secure and sensitive data, such as confidential documents, customer personally identifiable information, and account data. Therefore, it can be desirable to protect transmissions of such data using secure network protocols and encryption, and/or to protect the integrity of the data when stored on the various computing devices. For example, a file-based integration scheme or a service-based integration scheme can be utilized for transmitting data between the various computing devices. Data can be transmitted using various network communication protocols. Secure data transmission protocols and/or encryption can be used in file transfers to protect the integrity of the data, for example, File Transfer Protocol (FTP), Secure File Transfer Protocol (SFTP), and/or Pretty Good Privacy (PGP) encryption. In many embodiments, one or more web services can be implemented within the various computing devices. Web services can be accessed by authorized external devices and users to support input, extraction, and manipulation of data between the various computing devices in the operating environment 100. Web services built to support a personalized display system can be cross-domain and/or cross-platform, and can be built for enterprise use. Data can be transmitted using the Secure Sockets Layer (SSL) or Transport Layer Security (TLS) protocol to provide secure connections between the computing devices. Web services can be implemented using the WS-Security standard, providing for secure SOAP messages using XML encryption. Specialized hardware can be used to provide secure web services. For example, secure network appliances can include built-in features such as hardware-accelerated SSL and HTTPS, WS-Security, and/or firewalls. Such specialized hardware can be installed and configured in the operating environment 100 in front of one or more computing devices such that any external devices can communicate directly with the specialized hardware.

Turning now to FIG. 2, a computing device (e.g., an artificial intelligence (AI)-based knowledge distillation and paper production computing system 200) that can be used with one or more of the computational systems is described. The AI-based knowledge distillation and paper production computing system 200 can include a processor 203 for controlling overall operation of the artificial intelligence (AD-based knowledge distillation and paper production computing system 200 and its associated components, including RAM 205, ROM 207, input/output device 209, communication interface 211, and/or memory 215. A data bus can interconnect processor(s) 203, RAM 205, ROM 207, memory 215, I/O device 209, and/or communication interface 211. In some embodiments, the AI-based knowledge distillation and paper production computing system 200 can represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 can include a microphone, keypad, touch screen, and/or stylus through which a user of the AI-based knowledge distillation and paper production computing system 200 can provide input, and can also include one or more of a speaker for providing audio output and a video display device for providing textual, audiovisual, and/or graphical output. Software can be stored within memory 215 to provide instructions to processor 203 allowing AI-based knowledge distillation and paper production computing system 200 to perform various actions. For example, memory 215 can store software used by the AI-based knowledge distillation and paper production computing system 200, such as an operating system 217, application programs 219, and/or an associated internal database 221. The various hardware memory units in memory 215 can include volatile and nonvolatile, removable and non-removable media implemented in any method or technology for storage of information such as computer-readable instructions, data structures, program modules, or other data. Memory 215 can include one or more physical persistent memory devices and/or one or more non-persistent memory devices. Memory 215 can include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that can be used to store the desired information and that can be accessed by processor 203.

Communication interface 211 can include one or more transceivers, digital signal processors, and/or additional circuitry and software for communicating via any network, wired or wireless, using any protocol as described herein.

Processor 203 can include a single central processing unit (CPU), which can be a single-core or multi-core processor, or can include multiple CPUs. Processor(s) 203 and associated components can allow the AI-based knowledge distillation and paper production computing system 200 to execute a series of computer-readable instructions to perform some or all of the processes described herein. Although not shown in FIG. 2, various elements within memory 215 or other components in AI-based knowledge distillation and paper production computing system 200, can include one or more caches, for example, CPU caches used by the processor 203, page caches used by the operating system 217, disk caches of a hard drive, and/or database caches used to cache content from database 221. For embodiments including a CPU cache, the CPU cache can be used by one or more processors 203 to reduce memory latency and access time. A processor 203 can retrieve data from or write data to the CPU cache rather than reading/writing to memory 215, which can improve the speed of these operations. In some examples, a database cache can be created in which certain data from a database 221 is cached in a separate smaller database in a memory separate from the database, such as in RAM 205 or on a separate computing device. For instance, in a multi-tiered application, a database cache on an application server can reduce data retrieval and data manipulation time by not needing to communicate over a network with a back-end database server. These types of caches and others can be included in various embodiments, and can provide potential advantages in certain implementations of devices, systems, and methods described herein, such as faster response times and less dependence on network conditions when transmitting and receiving data.

Although various components of AI-based knowledge distillation and paper production computing system 200 are described separately, functionality of the various components can be combined and/or performed by a single component and/or multiple computing devices in communication without departing from the invention.

### Knowledge Distillation

Given the vast amount of research articles in different areas of science and humanities, efficient retrieval and condensing of relevant information is crucial for our ability to utilize humanities knowledge. While search engines and data mining facilitate finding of candidate articles and/or publications in relation to a query, casting the collected information in a coherent form, as humans do in presentations, review articles, or textbooks, has not been fully achieved yet. Here, an artificial (AI)-based knowledge distillation and paper production computing system provides a pipeline for creating review articles that combines science of science method with a transformer-based machine learning (ML) architecture (e.g., seq2seq) to create a complete review article. We assess the quality of each step of our pipeline and discuss challenges and future steps to improve the quality of the final outcome. The AI-based knowledge distillation and paper production computing system 200 embodies a proof of concept in the direction of creating AI capable of coherent summarization of multiple textual sources and aides in scientific writing. Further, the AI-based knowledge distillation and paper production computing system 200 may reduce the burden of electronically sorting, distilling, and/or condensing scientific articles and other information sources, thus, accelerating the improvement of information processing computing systems.

Scientific publication is growing exponentially, doubling almost every nine years, and it is becoming increasingly difficult to keep up with the developments in various fields. The task of condensing information on any major topic can be quite daunting. Hence, many scholars have worked on automated systems for retrieval of work related to a specific subject, for instance, computing systems programmed to recommend citations. However, this task remains quite challenging and the performance of computing systems programmed to use existing methods is rather poor, Yet, citation recommendations are useful when the context and the flow of a piece of writing already exists. As such, an AI-based knowledge distillation and paper production computing system 200 may be configured to automate a whole pipeline of the writing process to create and output a full article on an existing topic. To achieve this, the AI-based knowledge distillation and paper production computing system 200 not only must find the most relevant articles in a subject, but also be able to coherently compose a text based on these articles.

As is true for most of science, a subject can have many sub-branches that need to be discussed separately in separate sections of the article. Additionally, the way in which the material cited in each section appears aligns with both proper crediting of pioneering work, as well as including a smoothness and coherence of the flow of a section. All these steps can each be quite challenging and many different styles for writing and storytelling may be possible. Finally, the AI-based knowledge distillation and paper production computing system 200 may be configured to identify a main message of each cited work to fulfill the task of creating a text based on existing knowledge, not only identifying sources, and distilling of the information. Recently, advances in the area of natural language processing (NLP), especially the invention of the Transformer architecture have dramatically improved seq2seq and machine translation tasks. Many models are based on bidirectional encoder representations from transformers (BERT) architecture and the have been successfully used for text summarization tasks—an important component integrated with the AI-based knowledge distillation and paper production computing system functionality. For example, BERT comprises a transformer language model having a variable number of encoder layers and self-attention heads. Additionally, BERT models may be pretrained on two tasks: language modelling and next sentence prediction, where the BERT model may be trained to predict a probability that a next sentence given a previous sentence.

In some cases, BERT models may learn contextual embeddings for words and after computationally intensive pretraining, the BERT models may be finetuned with less resources on smaller datasets to optimize its performance on specific tasks. For example, the AI-based knowledge distillation and paper production computing system 200 may use a summarizer 233 based on BERT to fulfill the knowledge distillation part of the programmed functionality. Additionally, as mentioned, BERT-based models may additionally require fine-tuning on specific text data that may be relevant to a specific given work. For example, the summarizer 233 of the AI-based knowledge distillation and paper production computing system 200 may be configured to output a summarization that provides an understanding of which portions of text are of interest from a scientific point of view. The summarizer 233, via machine learning, may also learn a style of scientific citation contexts, such as how to compose text relating to a written work that is being cited. To accomplish this task, the summarizer 233 of the AI-based knowledge distillation and paper production computing system 200 may be retrained using information from articles and information as to how the articles are to be cited. In some cases, the composition and order of appearance of various cited work in a section may be more difficult to determine. In some cases, the AI-based knowledge distillation and paper production computing system 200 may learn one or more patterns employed by human writers and, based on one or more parameters (e.g., structure of the data sources, an intended audience for the automatically generated paper, a number of sources, types of sources, and the like) such as by choosing one (or more) of the identified writing styles for the automated system and incorporating the writing styles into the automated generation process. In another example, the AI-based knowledge distillation and paper production computing system 200 may take an unsupervised approach, relying on bibliometric information such as publication date and citation count. In some cases, the AI-based knowledge distillation and paper production computing system 200 may take a supervised approach. In some cases, components of the unsupervised approach may be applied to one or more base writing styles, such as an identified writing style from a plurality of writing styles associated with a target audience.

In summary, the AI-based knowledge distillation and paper production computing system 200 is configured to solve the problem of automatic knowledge distillation by facilitating a pipeline to create review articles on a given scientific topic. This pipeline includes three main components:
(1) a recommendation system for relevant articles to be cited;
(2) a clustering and sorting algorithmic engine for composing sections and defining order of articles within sections; and
(3) a summarization engine based on BERT and fine-tuned on scientific citation context data.

As a review, output from the AI-based knowledge distillation and paper production computing system 200 was examined by human experts and by systems processing a set of metrics and a software package used for evaluating automatic summarization and machine translation software in natural language processing, the Recall-Oriented Understudy for Gisting Evaluation (ROUGE) metric, to evaluate the quality of the final paper. Results of the summarization are comparable to the actual citation contexts.

Systems and methods in accordance with embodiments of the disclosure automatically process research papers to distill knowledge by designing a pipeline to create review articles on a given scientific topic. This pipeline includes a recommendation system for relevant articles to be cited, clustering and sorting algorithm for composing sections and defining order of articles within sections, and text summarization based on BERT and fine-tuned on scientific citation context data.

In the first step, suitable papers can be suggested to be cited in a review paper from the given single seed. We rely on science of science measures (detailed below) and co-citation patterns of a seed paper, which guarantees finding relevant potential references. A BERT based architecture fine-tuned on citation context can be used to summarize the abstract of a paper to a sentence or two. To compose the paper into sections, a principal component analysis and k-means clustering can be performed on the list of references based on the contents of their abstracts. Within each section, the papers can be arranged based on co-citations with the seed paper as well as other science of science measures.

There are unique differentiators in the three main areas of this innovation. First, current methodologies are limited by the ability to gain access to full texts of paper, challenges of processing any full texts obtained, as well as challenges of identifying topical similarity (also tied to access to texts). Citation recommendation for review papers have been considered. The techniques described herein have several differences with respect to prior art techniques in several key areas including, but not limited to, the use of a ‘Giant Paper’ effectively the most prominent paper in a given field selected with machine learning, a unique data set selection that filters, by one or more filters 231 of the AI-based knowledge distillation and paper production computing system 200based upon the solo giant papers among references and making potential references of each review by collecting all co-cited papers of its giant published until the end of the review; a recommender system that utilizes bibliometric features such as citation C9t), to co-citation with the corresponding giant D9t) at the year of the review paper (t), and performance of the recommendation using CGBoost to improve the results of the naive approach of co-citation.

The use of transformer-based models, such as those managed by the modeling engine 235, in various natural language processing (NLP) tasks can outperform existing use of recurrent neural networks (RNN) in existing methods. Key components of this differentiation include, but are not limited to, training a RF-IDF algorithm with abstracts of a review and all co-cited papers after lemmatization and grouping papers into sections and considering a variety of ordering structures (i.e. variance-based ordering, degree centrality and other rankings) as well as order of papers within sections.

It should be readily apparent to one having ordinary skill in the art that a variety of machine learning models of the modeling engine 235 can be utilized including (but not limited to) decision trees, k-nearest neighbors, support vector machines (SVM), neural networks (NN), recurrent neural networks (RNN), convolutional neural networks (CNN), probabilistic neural networks (PNN), and transformer-based architectures. RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine learning models can be utilized by the modeling engine 235, more specific machine learning models when available, and general machine learning models at other times can further increase the accuracy of predictions.

Most existing techniques utilize full text documents and summarize content/contribution of a paper through extractive methods, which ID the key aspects of a paper and then select representative sentences accordingly. The techniques described herein utilize BERT-based abstractive frameworks in news summarization and fine-tunes the model by the modeling engine 235 with scientific publications and their citation context through a unique training based on a curated dataset of MAG that is trained using a unique methodology intended to train the model on domain differences.

A variety of processes that can be used in accordance with embodiments of the invention are described and discussed below.

Citation Recommendation

Many studies have suggested various approaches to recommend papers associated with the general topics of a given paper or contexts of sentences where the citation is needed. This task requires detecting relevant topics of papers from abstracts or paragraphs having citations and understanding the context of each topic. By incorporating the full text of papers, content-based citation recommendation has been well studied. However, challenges in obtaining the full text of each paper and subsequently processing of those papers has been a limiting factor in most studies. Moreover, detecting topical similarity also depends on a number of papers that share the same topics, again limited by the number of papers. Hence, paper metadata such as authors and venue have also been incorporated to improve content-based recommendation systems, such as in making personalized systems based on a user's citation history. Recently, a content-based system for recommendation without topic modeling has been introduced. This system, by searching papers near a query paper in embedding space, shows better performance than previous results. Additionally, citation recommendations, especially for review papers, have also been considered. Different from other studies aiming to suggest suitable references for paragraphs, it focuses on finding papers to be cited in reviews. Further, it reveals that most of references can be found through citation relations starting from a few seed papers included in the review. However, that study has been limited to six reviews, and its method suggests that hundreds of references may be found from three seeds, of which size is tens of times larger than the actual number of references available.

Scientific Paper Summarization

Due to the exponential increase of scientific publications, more and more text summarization studies started to investigate scientific papers. Most scientific paper summarization studies utilize full-text documents and summarizes the content and/or contribution of a paper through extractive methods, which identify the key aspects of a paper and then select representative sentences accordingly. Recently, neural abstractive summarization has been applied to scientific papers, which uses a decoder to generate sentences that may contain phrases similar to how humans summarize documents. Yet, the abstractive summarization of scientific papers uses Recurrent Neural Network, which was shown to be outperformed by transformer-based models in various natural language processing (NLP) tasks in recent studies. Although transformer-based language models have been applied to different NLP tasks, such as automatic question and answer, sentence prediction, and abstractive summarization, current language models were mainly trained on news and Wikipedia pages. Given the different nature of news summarization and scientific paper summarization, the AI-based knowledge distillation and paper production computing system 200 builds upon the pretrained language models and are fine-tuned and improved by the modeling engine 235. Some recent studies began adapting BERT to scientific papers, such as BIOBERT trained on PubMed dataset, SCIERC on 500 scientific abstracts and SCIBERT on Semantic Scholar. However, these models focused mainly on tasks such as named entity recognition and relation extraction. Thus, to fill the gap in the literature on scientific paper summarization with transformer-based language models, the AI-based knowledge distillation and paper production computing system 200 utilizes citation-context for summarization labels, and uses openly accessed metadata such as abstract and keywords as input.

Previous studies in citation recommendation and paper summarization suggest that citation contexts contain valuable information related to the contribution of a particular paper. Further, citation-context is particularly useful for the AI-based knowledge distillation and paper production computing system review process, as a goal of the review is to provide an understanding about how each paper contributes to a particular research field. Moreover, it allows the AI-based knowledge distillation and paper production computing system 200 to train the summarization model in a discipline-free manner, and also overcomes limitations of previous studies that required expert annotations from specific domain(s) of study. The AI-based knowledge distillation and paper production computing system 200 is designed to produce a review paper automatically using a recommendation system for citations and one or more transformers for text summarization and composition. In an illustrative example, the AI-based knowledge distillation and paper production computing system 200 may first suggest suitable papers to be cited in a review paper from a given single seed. The AI-based knowledge distillation and paper production computing system 200 may rely on the science of science measures, as discussed in more detail below, and co-citation patterns of a seed paper, which guarantees finding relevant potential references. Next, the AI-based knowledge distillation and paper production computing system 200 may use a BERT-based architecture that is fine-tuned on citation context to summarize the abstract of each paper to a sentence or two. The AI-based knowledge distillation and paper production computing system 200 may then compose the paper in sections by performing a principal component analysis (PCA) and k-means clustering on the list of references based on the identified contents of their abstracts. Within each section, the AI-based knowledge distillation and paper production computing system 200 arranges the papers based on co-citations associated with the seed paper as well as other science of science measures.

### Reference Recommendation

The number of published papers has accelerating rapidly. Between 1954 and 2014, over 42 million papers were published in Web of Science (WOS), and 87 million papers have been collected in Microsoft® Academic Graph. To write a review on a specific research topic, a crucial step is the collection of papers relevant to topics associated with the review. To discover patterns about how domain experts have chosen papers to be referenced with respect to different review papers, we analyzed the references of almost 23,000 review papers in WOS until 2014. Reviews do not cite plenty of papers having similar topics for those reasons. First, reviews usually aim to introduce recent progress and issues as discussed in the papers, implying that an old paper in the same field could be less likely to be cited in spite of the relevance with others. Second, citation also matters to predict what papers are cited in reviews, as reviews are a measure of impact, and highly cited papers are more likely to be included in a review paper. To better learn the choice of references in review papers, the AI-based knowledge distillation and paper production computing system 200 utilizes machine learning (ML) methods with measures in science of science. The potential list of references includes papers that are quite relevant to the corresponding reviews, some of which are referenced in the review. To restrict the search space for relevant papers, the AI-based knowledge distillation and paper production computing system 200 may first filter, by the filter 231, the relevant papers using a seed paper, which we will call the “giant paper” and is introduced below. The giant paper will be the input “seed” to the ML system and may be, in a sense, the most prominent paper in a given field.

Giant Paper

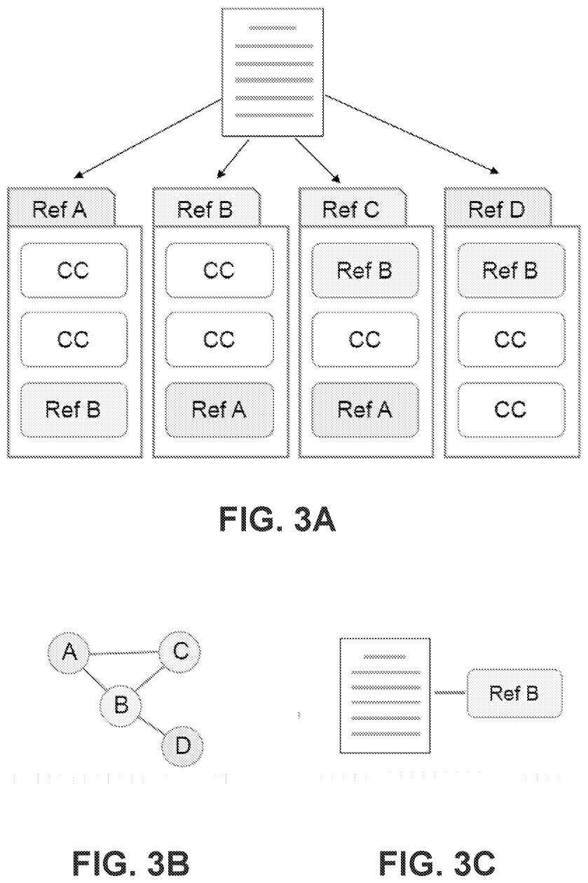

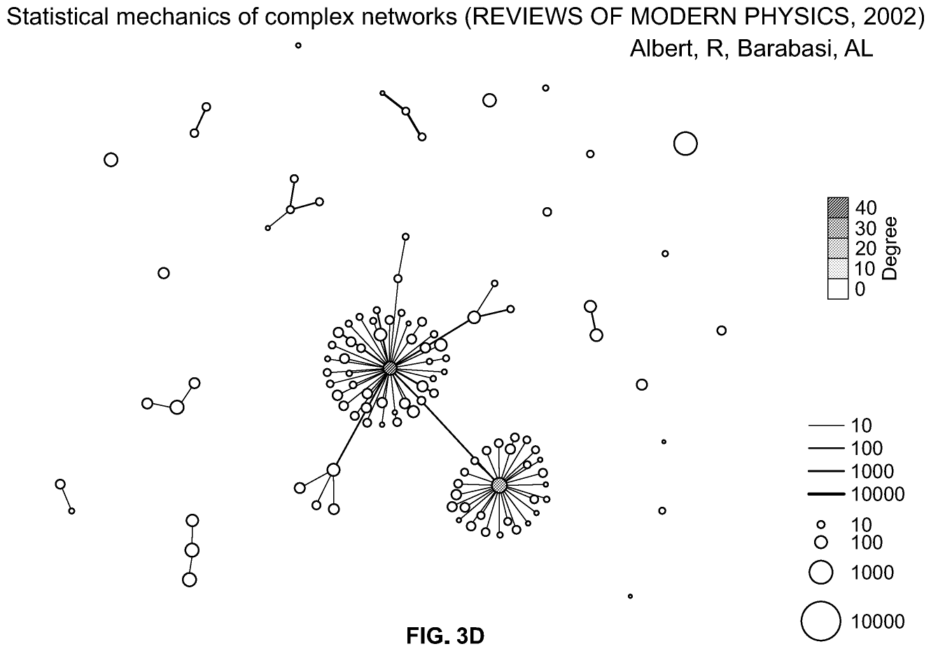

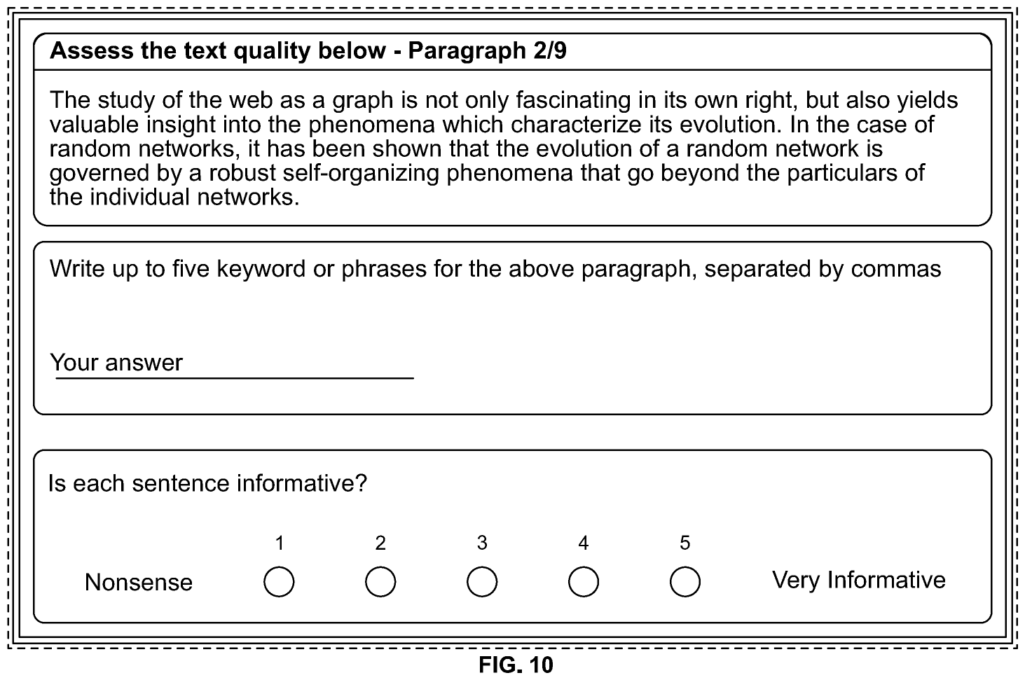

FIG. 3A shows an illustrative representation of a top 3 most co-cited (CC) papers of four references in the paper, FIG. 3B shows an illustrative graph where nodes are all references of the review and connected through top 3 co-citations, FIG. 3C shows a solo giant paper of the review, and FIG. 3D shows an illustrative example of the review paper on complex networks. Co-citation is regarded as a measure of closeness between two papers. For example, if paper A is cited in n papers with paper B together, then one says paper A has n co-citation with paper B. If paper A shares similar research topics with paper B, then they are more likely to be cited together by ensuing research. Hence, co-citation may be used as a proxy for topic similarity of papers, where topic similarity reflects consensus on papers generated by experts' citation behaviors. In some cases, many references can be captured by a few seed references through co-citation relationships. This capture implies that a good seed is capable of capturing most references as well as related papers determined from the references. Therefore, the AI-based knowledge distillation and paper production computing system 200 may process instructions to process a new method to find the best seed reference with which the AI-based knowledge distillation and paper production computing system 200 can find the most references with higher co-citation on average. In some cases, the best seed paper the giant paper. To find a giant paper for each review, the AI-based knowledge distillation and paper production computing system 200 collects N_{ref} references of a review and constructs lists of co-cited papers for each reference. Since the size of co-cited papers are heterogeneous on references, the AI-based knowledge distillation and paper production computing system 200 adjusts the size by picking a top i o-cited papers in every list (i.e., i=3 in FIG. 3A) and find what references are shown in top i co-cited papers in the lists. As an example, the reference B may be captured three times, and the reference A is highlighted twice in the top three co-cited papers in FIG. 3A. To set the proper threshold i, the AI-based knowledge distillation and paper production computing system 200 borrows the percolation threshold in a random graph. The AI-based knowledge distillation and paper production computing system 200 makes a graph comprised of the captured references in top i co-cited papers with their co-cited relations, as shown in FIG. 3B. The AI-based knowledge distillation and paper production computing system 200 then sets the minimum i as the threshold which satisfies [symbol] k [symbol] >1. In the end, the giant paper is determined to be the most observed reference in the N_{ref} lists of top i co-cited papers in FIG. 10.

Data Set

To learn how references in the existing reviews are chosen, the AI-based knowledge distillation and paper production computing system 200 utilizes the Web of Science (WOS) dataset which contains more than 42 million papers published until 2014. Every paper in WOS comprises reference and document type metadata, which enable the AI-based knowledge distillation and paper production computing system 200 to select review papers. To make a clear sample for reviews, the AI-based knowledge distillation and paper production computing system 200 selects a large number of quality reviews (e.g., 28,698 good quality reviews which have at least 50 references, 100 citations in 2014), and reviews keywords in either abstracts or title of the references. Fields of review papers also may be highly skewed. The AI-based knowledge distillation and paper production computing system 200 may choose a number of research fields (e.g., 81 research fields in which at least 50 reviews exist in the selected reviews). Then, the AI-based knowledge distillation and paper production computing system 200 may pick a maximum number of review papers (e.g. at most 200 review papers) randomly in every field. By doing so, the AI-based knowledge distillation and paper production computing system 200 finally selects a specified number (e.g., about 11,000, about 10,782, etc.) of reviews.

For the selected papers, the AI-based knowledge distillation and paper production computing system 200 may find solo giant papers among references and make potential references of each review by collecting all co-cited papers of the identified giant published until the year of the review. The AI-based knowledge distillation and paper production computing system 200 may then check that a percentage (e.g., 70%, 80%, etc.) of references of a review is overlapped with the potential references coming from the giant paper, which is similar to the maximum fraction of the overlap (e.g., 63%) found in a previous study. This supports the assumption that most of references would be co-cited with the giant in higher rank.

Experimental results have shown that an average size of references is 91 while the number of co-cited papers can be an order of tens of thousands. This discrepancy makes large ratio of references to others out of references. In selected reviews performed by the AI-based knowledge distillation and paper production computing system 200, the ratio of positive to negative is almost 50 on average. To resolve the imbalance of negative samples, the AI-based knowledge distillation and paper production computing system 200 selects papers out of references randomly to keep the ratio of one positive to four negative cases in the training set. Table 1 shows the basic statistics of the data sets for training and testing the model such as by the modeling engine 235.

TABLE 1
Statistics of data of references for reviews

| | |
|---|---|
| # of reviews in training set | 8,625 |
| # of papers in training set | 3,927,595 |
| # of reviews in test set | 2,157 |
| # of papers in test set | 23,442,858 |
| # of references on average | 91 |

Recommendation System

A relevant paper is more likely to be cited in a review if its impact is noticeable. Citation itself is a measure of scientific impact, and co-citation with the giant paper of the review represents a strength of semantic closeness to the review. Therefore, the AI-based knowledge distillation and paper production computing system 200 utilize bibliometric features such as citation C(t), the co-citation with the corresponding giant D(t) at the year of the review paper t.

Citation may be easily affected by external factors such as an age of paper and a field to which the paper belongs. Since review papers in an analyzed sample were distributed over 81 research fields in different years, the AI-based knowledge distillation and paper production computing system 200 normalizes citation C and co-citation D with its giant paper's citation and the maximum of co-citation in every review, respectively. In addition, to reflect retrospective approach, the AI-based knowledge distillation and paper production computing system 200 computes citation of papers and co-citation with the giant paper at the year of the review. the AI-based knowledge distillation and paper production computing system 200 also incorporate the publication year difference Δt between the giant paper and a chosen paper. As a result, we utilize three features C/C_{giant}, D/Dₘₐₓ, and Δt.

The giant paper sometimes can cover a higher topic and multiple topics. For example, the topic “complex networks” is illustrative of a higher category that covers various sub-topics such as “types of network models”, “studies on structures”, and “methodologies on computations”. To assign more weights to relevant papers in specialized topics, the AI-based knowledge distillation and paper production computing system 200 applies term frequency-inverse document frequency (TF-IDF) to all abstracts of potential papers after stemming process and extract top 10 keywords from the abstract of the review. TF-IDF is a numerical statistic used to reflect an importance of a word is to a document in a collection of documents and may be used as a weighting factor in searches of information retrieval, text mining, and user modeling. In some cases, a TF-IDF value may increase proportionally to a number of times a word appears in the document and may be offset by a number of documents in a set that contain the word, which helps to adjust for the fact that some words appear more frequently in general. the AI-based knowledge distillation and paper production computing system 200 may then calculate the fractional overlap fₒᵥₑᵣₗₐₚ of top 10 keywords to an abstract of each paper.

Here, a goal for the AI-based knowledge distillation and paper production computing system 200 may be to identify suitable references for a review using bibliometric measures and/or the fraction of overlapping keywords. As a suggestion system, the modeling engine 235 of the AI-based knowledge distillation and paper production computing system 200 utilizes three methods: Logistic regression as a baseline model, a neural model with a single hidden layer, and use of an XGBoost algorithmic model. For the neural model, the AI-based knowledge distillation and paper production computing system 200 measures precision, recall, and F1-score at the top 90 suggested references for each reviews in the testing set. To compare performance of ML-based methods, the AI-based knowledge distillation and paper production computing system 200 also introduces a naive approach based on citation and co-citation itself. In these approaches, the AI-based knowledge distillation and paper production computing system 200 picks the top potential papers (e.g., 90 potential papers) in sort of citation and co-citation and regard them as positive cases.

Performance of the Recommendation

Citation is an indication of an impact of papers in general, and co-citation implies a topical closeness with an academic impact. Hence, the AI-based knowledge distillation and paper production computing system 200 may consider that picking 90 potential papers by a solo measure is a baseline in this study and may categorize the picked potential papers as a baseline. Since the testing set is highly imbalanced (p/n≈0.0084), picking a reference randomly is not considered as a baseline model. As shown below, Table 2 reports P@90, R@90, and F1@90 with five methods for all co-cited papers of reviews in an illustrative testing set. Citation method shows the lowest F1-score than picking papers by co-citation, meaning that papers which are quite close topically are chosen as references even though highly cited papers have co-citation with a giant paper.

TABLE 2
Precision, recall, and F1-score for top 90 suggested references.

| Method | P@90 | R@90 | F1@90 |
|---|---|---|---|
| Citation | 0.014 | 0.020 | 0.029 |
| Co-citation | 0.243 | 0.277 | 0.239 |
| Logistic Regression | 0.260 | 0.300 | 0.258 |
| Neural model | 0.282 | 0.323 | 0.279 |
| XGBoost | 0.291 | 0.333 | 0.288 |

The performance with the machine learning algorithms is improved over the naive method with co-citation. However, co-citation governs the classification in the logistic regression, for a particular example, where the coefficient for D/Dₘₐₓ is 40 whereas the next largest coefficient is near 5. The overwhelming effect of co-citation is also observed in the neural model. To check the weights of features in the trained model, the AI-based knowledge distillation and paper production computing system 200 obtained the weight matrix Win between the input layer i and the hidden layer h and who between the hidden layer to the output one. By computing Will who, we obtain the weight vector for features, revealing that at least 40 times larger weight is assigned to the co-citation.

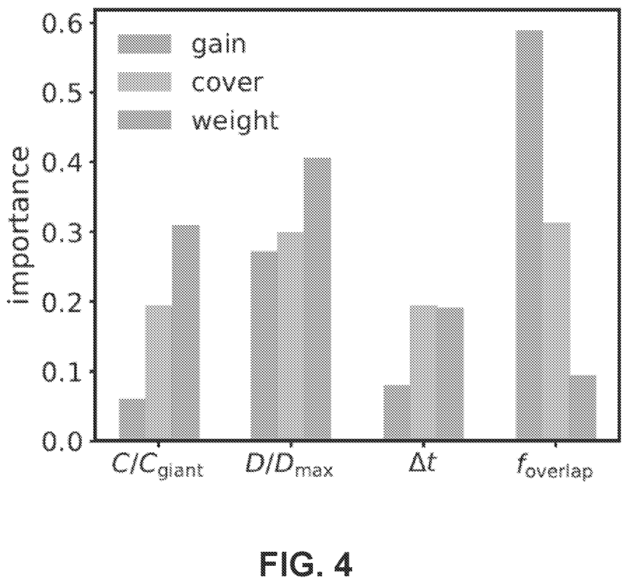

FIG. 4 shows a graphical representation illustrative of feature importance with using an XGBoost algorithm. Among three methods based on machine learning algorithms, XGBoost shows the best performance in precision, recall, and F1-score. In summary, all measures with XGBoost are improved over 20% compared to the results of the naive approach with co-citation. FIG. 4 demonstrates the importance of features in three aspects: gain, cover, and weight normalized by the maximum of each importance. Interestingly, the keyword overlap fₒᵥₑᵣₗₐₚ has the most contribution to the model for predicting the classification. The gain of normalized co-citation D/Dmax accounts for 0.3 which is half of the relative gain of fₒᵥₑᵣₗₐₚ contrary to other models governed by co-citation overwhelmingly. The cover means how many observations are classified by a feature in the last. It shows that observations are finally classified by all features evenly. The weight indicates the number of times a feature split samples in trees. The normalized co-citation is most used to predict the class, implying that co-citation is also important in prediction.

### Organization of the Review Papers

Once the AI-based knowledge distillation and paper production computing system 200 has determined a list of candidate papers to be used to generate the review paper, the AI-based knowledge distillation and paper production computing system 200 organizes them into sections for the paper. Each section focuses on a particular subtopic, ideally organized in order of their importance in the field. To organize the structure of the review paper, the AI-based knowledge distillation and paper production computing system 200 determines: 1) Which papers to combine in one section; 2) an order of the sections; 3) An order of papers within each section, as described below.

Grouping Papers into Sections

To decide which paper goes into each section multiple clustering methods were tested based on the contents of the abstracts of papers. The AI-based knowledge distillation and paper production computing system 200 groups the papers based on their content and topics. To identify similarity in topics, the AI-based knowledge distillation and paper production computing system 200 may use both embedding of the abstracts of the papers and/or extracting keywords. Bibliometric measures such as citation do not provide research domains and keywords directly. This is because papers having the same research keywords in different fields would be underrepresented due to lower co-citations with papers in a target field. For example, papers about complex networks in biology would have smaller co-citation with papers in physics relatively. Thus, the AI-based knowledge distillation and paper production computing system 200 considers other topics beyond co-citation to identify topic similarity.

To utilize keywords in a semantic way, the AI-based knowledge distillation and paper production computing system 200 trains a TF-IDF algorithm with abstracts of a review and all co-cited papers after a lemmatization process is performed. Then, the AI-based knowledge distillation and paper production computing system 200 identifies the ten most relevant keywords from the abstract of a given review paper. the AI-based knowledge distillation and paper production computing system 200 calculates a number of selected keywords that are observed in the abstract of each co-cited paper and normalizes it with the number of selected keywords. This overlap with the top ten keywords of the review is one of the input features for the recommender system. To find keywords and overlap among all the candidate papers, the AI-based knowledge distillation and paper production computing system 200 applies TF-IDF to abstracts of all co-cited papers to obtain a long TF-IDF vector with many keywords for every paper. The filter 231 of the AI-based knowledge distillation and paper production computing system 200 then filters out noisy keywords used in less than a percentage (e.g., 1%) of all papers. The AI-based knowledge distillation and paper production computing system 200 uses the set of all these accepted keywords and assigns one large vector to each paper, where the vector indicates the number of the times each keyword appeared in the abstract of that paper as normalized by the total number of words in the abstract.

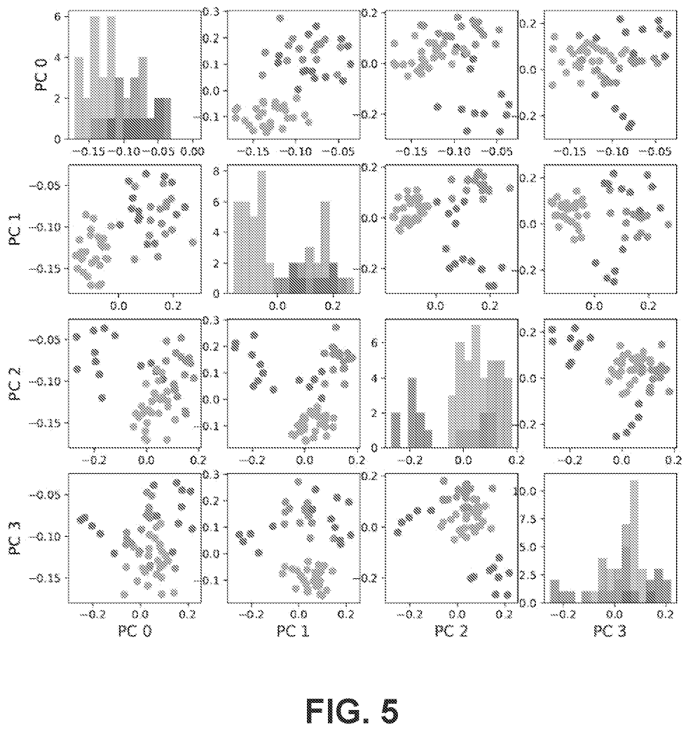

Once the AI-based knowledge distillation and paper production computing system 200 determines the matrix K with potential references in each row and the vector of keywords present in each as columns, the AI-based knowledge distillation and paper production computing system 200 processes instructions to perform one or more different clustering methods to find sections. For example, the AI-based knowledge distillation and paper production computing system 200 may perform Principal Component Analysis (PCA) on various versions of K. In a first method, the AI-based knowledge distillation and paper production computing system 200 may perform a Singular Value Decomposition (SVD) on K. To get p sections for a review paper, the AI-based knowledge distillation and paper production computing system 200 may select the first p principal components (PC) and clustered them into p clusters using k-means. In another attempt, the AI-based knowledge distillation and paper production computing system 200 first constructed the Pearson correlation matrix Pᵢⱼ=(Kᵢ−K ᵢ)^{T} (Kⱼ−K ⱼ)/(σ_{Ki} σ_{Kj}) and did PCA and k-means on it. Further, the AI-based knowledge distillation and paper production computing system 200 also used A=K^{T}K−diga[K^{T}K] and did the same. In each case, the clusters come out slightly different. In some cases, the best results, based on subjective domain knowledge about certain fields, was PCA on the Pearson correlation. FIG. 5 shows clustering the papers into sections. Here, the AI-based knowledge distillation and paper production computing system 200 used K-means clustering of top 4 principal components of the Pearson correlation of TF-IDF keyword vectors for papers.

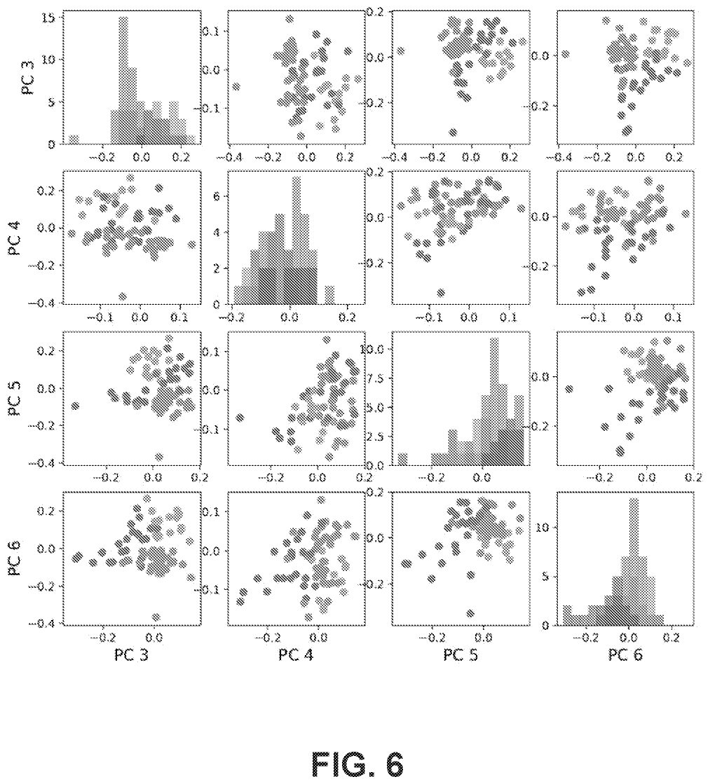

Instead of keywords found using TF-IDF, the AI-based knowledge distillation and paper production computing system 200 may also use BERT to embed the abstracts of papers and perform the same clustering using the average embedding vector of the abstract of each paper. FIG. 6 shows the result of clustering using BERT. For example, FIG. 6 shows clustering of papers into sections using BERT embedding. The AI-based knowledge distillation and paper production computing system 200 uses the same process as shown above for TF-IDF keywords.

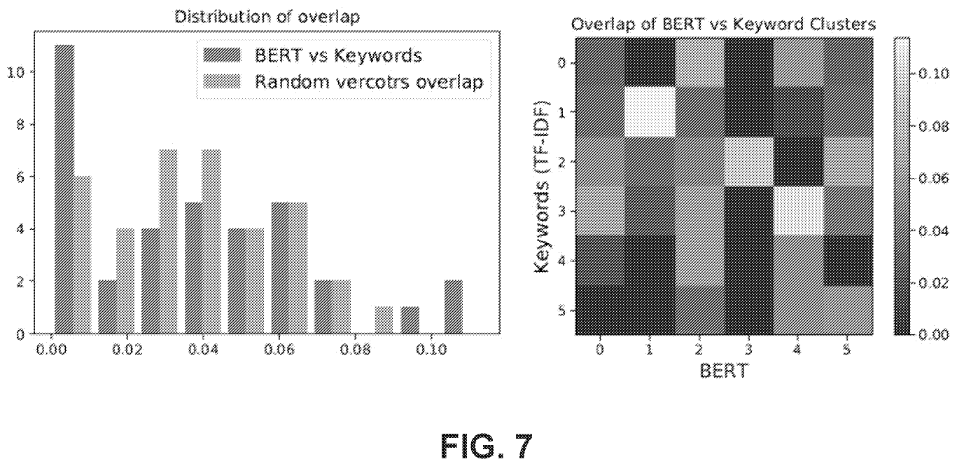

While qualitatively, the clustering using BERT and TF-IDF look similar, we note that in the BERT embedding the top three PC were not informative and needed to be removed before reasonable clusters could be found. Also, when comparing the clusters found by BERT and TF-IDF keywords, we find very little agreement (less than 10%) between them, as seen in FIG. 7. FIG. 7 shows an overlap between clusters found using BERT vs TFIDF keywords. The matrix on the right shows the level of overlap of all pairs of clusters among the two methods. The left histograms show the distribution of values in the similarity matrix on the right, compared to a similarity matrix calculated for random integer vectors. The overlap is calculated by the AI-based knowledge distillation and paper production computing system 200 as |C_{B}∩Cₖ|/(|C_{B}|+|Cₖ|/2), counting the number of similar papers in cluster C_{B} from BERT and Cₖ from keywords. The amount of agreement is slightly higher than among random integer vectors of the same structure and same size as C_{B} and Cₖ. The quality of the grouping in both cases seems reasonably good, where of sections of real review articles may be used to quantitatively rate this result. Next, the AI-based knowledge distillation and paper production computing system 200 determines an organization of the sections.

Order of Sections

Decision about ordering of sections can be somewhat subjective. Some authors may decide on a chronological order, while others may prefer one based on importance of each topic. In each case, it would be better to keep a degree of coherence in the flow across sections. To achieve this, the AI-based knowledge distillation and paper production computing system 200 ranked the sections based on one or more different factors, as described below.

Variance-based Ordering. In this method the argument is that the amount variance explained by each PC captures the significance of that PC. Therefore, ordering the sections based on how much variance their average cluster explains will conform to this measure of significance. To do so, the AI-based knowledge distillation and paper production computing system 200 determines the p dimensional vector K ₗ representing the center of cluster I in k-means, if keeping p of the PC. The amount of variance explained V by the PC is captured by the square of singular values or the eigenvalues of matrix we used for PCA (e.g. the eigenvalues of P). To assign an importance score to cluster I, the AI-based knowledge distillation and paper production computing system 200 calculate sₗ=K ₗ·Vₚ, where Vₚ are the first p elements of V. Finally, we order the sections based on their score sₗ.

Degree Centrality. Another idea is to sort the sections based on how central the section is in the topic. One way to capture this is to build a similarity network among different cluster and see which cluster gets the highest similarity weight with all other clusters. To do so, the AI-based knowledge distillation and paper production computing system 200 utilized two methods, one based on keywords and one based on closeness in the PCA embedding. For the keywords, the AI-based knowledge distillation and paper production computing system 200 first found the top ten keywords of each cluster. Then the AI-based knowledge distillation and paper production computing system 200 built the p×p matrix of overlap of these top keywords among all clusters. Finally, the AI-based knowledge distillation and paper production computing system 200 ordered the sections based on the sum over each row of the keyword overlap matrix, to put the clusters with the highest total overlaps first.

Another way to measure similarity is by looking at the distance of clusters in the embedding space of PCA. In this method the AI-based knowledge distillation and paper production computing system 200 built the p×p matrix of distances of cluster centers. With this method, the most central cluster will be the clusters with the smallest total distance to all other clusters.

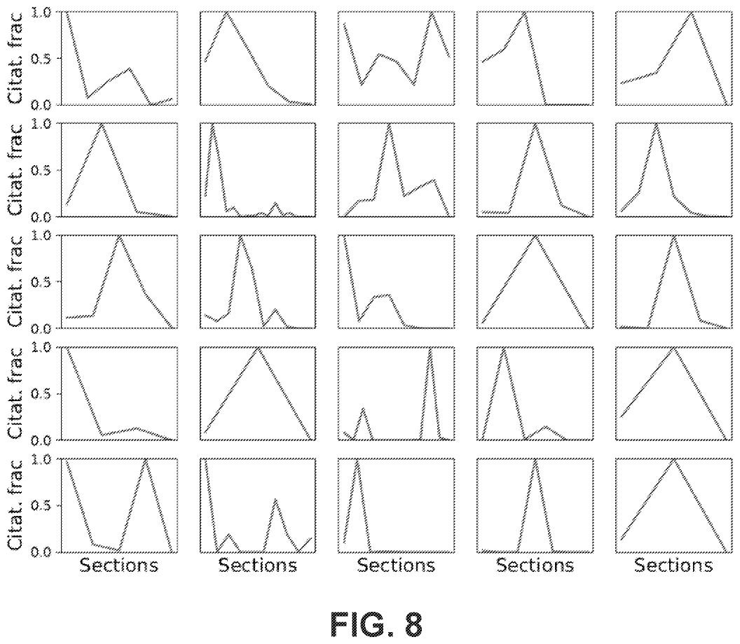

FIG. 8 shows a distribution of citation of references cited in various sections of 25 sample review papers. The AI-based knowledge distillation and paper production computing system 200 didn't determine a clear trend here, indicating the subjective or complex decision-making in structuring papers.

Other Rankings. In some cases, ranking of the clusters may be performed based on average publication year of papers, total citation, size of the cluster, etc. All these choices are somewhat subjective. To better mimic patterns used in real review papers, the AI-based knowledge distillation and paper production computing system 200 analyzes the order of appearance of papers and sections of real review papers. The distribution of fraction of total citation count for different section of 25 different review papers from the PubMed database3 are shown in FIG. 8. FIG. 8 shows a distribution of citation of references cited in various sections of 25 sample review papers. The AI-based knowledge distillation and paper production computing system 200 may not determine a clear trend here, indicating the subjective or complex decision-making in structuring papers. As can be seen, there is no clear trend and further processing of the information of the references may be performed to find the patterns in organizing the papers.

Order of Papers within Sections

The natural way to order the papers within sections would be a combination of impact and age of the paper. For example, a most seminal work on the topic possibly spurred much of the subsequent work in the section, which suggests that the papers would have a more or less chronological order. However, timing only matters when the impact of the work, through consideration of co-citation for instance, is considered. Further, the AI-based knowledge distillation and paper production computing system 200 may further process the structure of different full-text articles to improve the ordering of papers within sections.

### Scientific Paper Summarization

Given a pool of references for a review, the goal of summarization part is to generate a short summary of each paper from its abstract. The AI-based knowledge distillation and paper production computing system 200 can then connect the summaries by an order as previously learned and described above. To generate a proper summary of each paper, AI-based knowledge distillation and paper production computing system 200 builds upon a BERT-based abstractive framework in news summarization, and fine-tunes the model based on scientific publications and information corresponding to their citation context, where the training process is described below.

Data Set

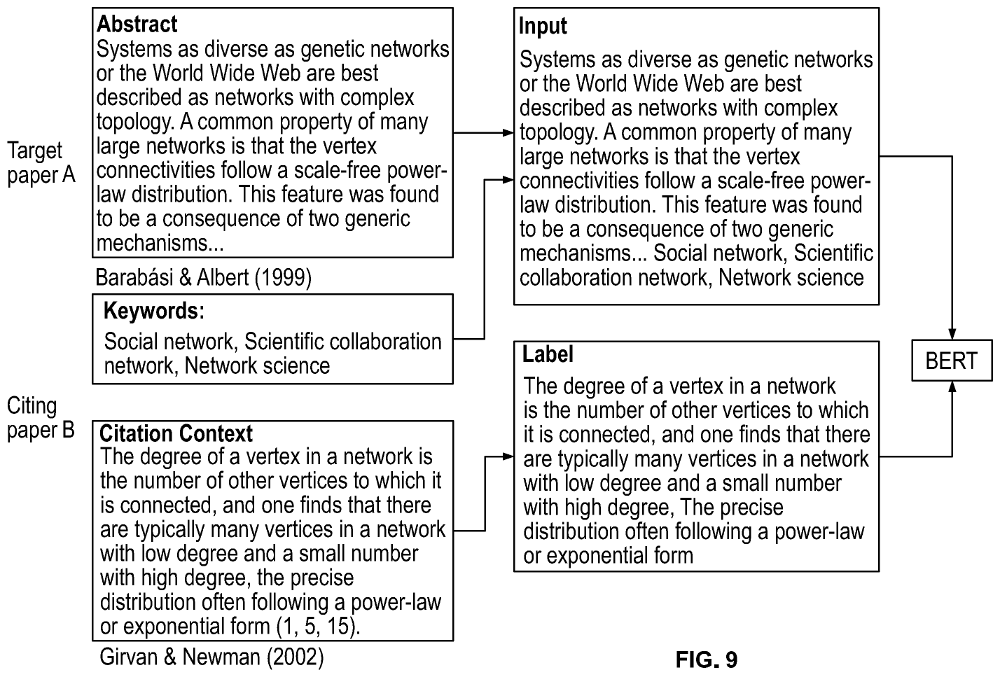

To learn proper summarization of each publication, AI-based knowledge distillation and paper production computing system 200 utilizes a large-scale scholarly dataset Microsoft® Academic Graph (MAG), which contains worldwide publication records between 1900 and 2018. Here the AI-based knowledge distillation and paper production computing system 200 analyzes papers that contain both abstract and citation context information in the dataset (e.g., paper text, metadata, etc.), whose abstract and context have at least 50 characters. The left part in FIG. 9 shows an example of citation context of the target paper A, where: Paper A was cited by paper B. The citation context of A is the text surrounding the citation marker in paper B when it mentions A. Note that the AI-based knowledge distillation and paper production computing system 200 may utilize more than one citation context for each paper, with the distribution of number of citation contexts being fat-tailed. Thus, to reduce the number of duplicate inputs during training, the AI-based knowledge distillation and paper production computing system 200 randomly sampled at most two citation contexts for each paper. If a paper has two different citation contexts the AI-based knowledge distillation and paper production computing system 200 treats them as two different samples. For each abstract and citation context pair, AI-based knowledge distillation and paper production computing system 200 may use the Python NLTK sentence tokenizer to split a paragraph into different sentences, or other similar tokenizers.

The AI-based knowledge distillation and paper production computing system 200 may then remove accents and special characters. As the pointer to each paper is usually represented as a number with parenthesis like III, which is irrelevant to generating summaries, additionally, the AI-based knowledge distillation and paper production computing system 200 further removes numbers and parenthesis in the citation context. After that the AI-based knowledge distillation and paper production computing system 200 finds citation context than less than 20 characters are mainly broken ones, and exclude those to improve the quality of the training set. Citing a paper in a context is subtler than simply summarizing a paper. Every paper B citing a paper A may focus on different aspects of paper A. To account for this richness, the AI-based knowledge distillation and paper production computing system 200 modifies the input for each citation context. Rather than the input being just the abstract of the paper A being cited, the AI-based knowledge distillation and paper production computing system 200 augments it by adding keywords of the citing paper B to the abstract of paper A, as shown in FIG. 9. FIG. 9 shows the model that encodes the abstract of the original paper and keywords from the citing papers and learns the summary from citation context of the citing paper. MAG provides multiple keywords for each paper, which captures the research topics (e.g. social network and network science for citing paper B).

This setting is important for two reasons: A paper can be summarized differently under different citing papers. For example, paper B highlights the scale-free distribution in paper A. But paper A might be highlighted for its non-biological properties in a metabolic network paper as shown in Table. 3.

TABLE 3
Citation contexts capture different aspects of a paper.

| Target | Systems as diverse as genetic networks or the World Wide Web |
|---|---|
| paper A | are best described as networks with complex topology. A |
| | common property of many large networks is that the vertex |
| | connectivities follow a scale-free power-law distribution . . . |
| Context | . . . the precise distribution often following a power-law or |
| 1 | exponential form . . . |
| Context | . . . the inherent organization of complex nonbiological |
| 2 | system . . . |

Similarly, citing papers from different fields have different focus of studies. By inserting the keywords of the citing paper in the input, the model may improve learning of domain differences. The statistics of the summarization dataset is shown in Table. 4.

TABLE 4
Statistics of Summarization Data.

| | |
|---|---|
| # of (abstract, context) pairs in the training set | 121,000 |
| # of (abstract, context) pairs in the validation set | 24,000 |
| # of (abstract, context) pairs in the testing set | 16,000 |
| # of unique papers | 81,834 |
| Average input length | 1,028 |
| Average context length | 284 |

Training Details

The AI-based knowledge distillation and paper production computing system 200 adopts the pre-trained abstractive BERT summarization model BERTSUMEXTABS on newspapers from and fine-tune it with our citation context data. It uses BERT-base-uncased vocabulary and each sentence is tokenized by BRET basic tokenizer. We set the batch size as 100, learning rate as 0.002, and dropout rate as 0.2, and train for 100,000 steps on 2 GPUs (GTX-2080 Ti).

Results

As citation contexts of a same paper may contain different perspectives of a paper, as seen in Table 3, the AI-based knowledge distillation and paper production computing system 200 may further quantify the level of consensus between two random citation contexts with ROUGE score, as shown in Table 5, for papers in the testing set. This may capture a similarity between two real-world scientists would summarize a paper as compared to one another. The AI-based knowledge distillation and paper production computing system 200 may find considerable discrepancies between summaries by written experts. The AI-based knowledge distillation and paper production computing system 200 may then use ROUGE-1, ROUGE-2 and ROUGE-L to evaluate the pre-trained BERTSUMEXTABS and find-tuned one on citation context.

TABLE 5
Model Evaluation. Machine-generated summaries produce meaningful
information, with comparable, even slightly higher score
to the two summaries generated by real scientists. Our
fine-tuned model outperforms the pretrained model.

| MODEL | ROUGE-1 | ROUGE-2 | ROUGE-L |
|---|---|---|---|
| pre-trained | 0.1764 | 0.0801 | 0.1341 |
| fine-tuned | 0.1834 | 0.0844 | 0.1388 |
| Contexts (same paper) | 0.1641 | 0.0419 | 0.1346 |
| Contexts (different papers) | 0.1263 | 0.0057 | 0.0982 |

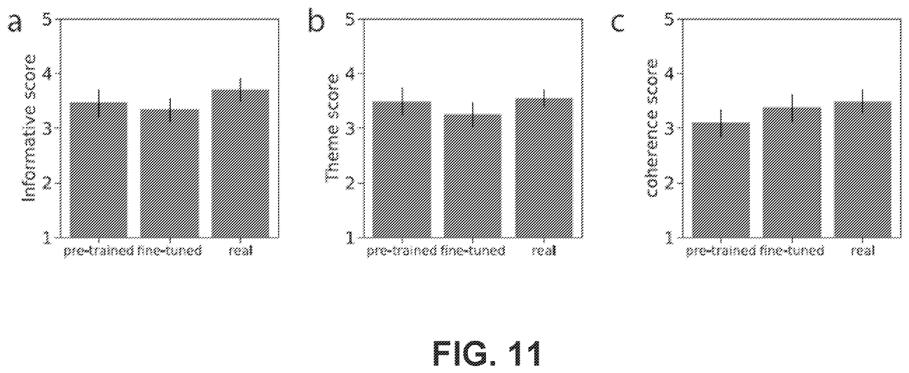

Table 5 summarizes the model performance under different metrics. The fine-tuned model outperforms the pre-trained one in terms of ROUGE score. Both models generated meaningful texts compared to the ROUGE score of citation contexts for two randomly selected papers. Interestingly, the machine-generated summaries have comparable, even slightly higher consistency between the real citation context, suggesting both pre-trained and fine-tuned models produce summaries matching citation context with the best possible. To further evaluate how human perceive these summaries, a survey was conducted for 11 experts on network science, which asked them to evaluate the summaries generated by the pre-trained model, the fine-tuned model and a real review paper. Specifically, 3 paragraphs were selected from the real review, and for each paragraph the AI-based knowledge distillation and paper production computing system 200 generated the summary for each reference within the paragraph, and ordered the paragraphs according to their order of appearance, resulting in 9 evaluation paragraphs. For each paragraph, the participants were asked to give score from 1 to 5 from three perspectives: informative sentences, clear paragraph theme, and the coherence between sentences. FIG. 10 shows a screenshot of the survey shows the screenshot of the survey for the summary generated by our fined-tuned model, and the survey results are presented in FIG. 11. For example, FIG. 11 shows the survey results for the summary of real, pretrained and fine-tuned model evaluated by 11 experts, where the machined-generated summaries have comparable quality with the real summaries in a review paper.

Consistent with the ROUGE score, evaluation from experts suggests that human generated (e.g., “real”) paragraphs have comparable scores with the machine-generated summaries from different perspectives. Although the real paragraphs receive the highest score among these cases, they do not significantly outperform machine-generated summaries. The pre-trained model seems to produce more informative summary with clearer themes. Yet, the fine-tuned model performs better than the pre-trained model in coherence. Additionally, participants were asked to give 5 key phrases for each paragraph, finding both models can capture on average 1 key phrase from the key phrases experts generated from real paragraphs. Two samples of machine generated actual summaries about the topic of “complex networks” are given below. These machine-generated summaries are portions of two different sections determined by our clustering procedure by the clustering engine 237, together with the references to the articles being summarized.

### DISCUSSION

The explosive scholarly datasets call for more efficient tools for knowledge organization and consumption. automatic review paper production by an AI-based knowledge distillation and paper production computing system 200 can efficiently and effectively address this problem. The proposed pipeline tackles and experiments with three key steps: 1) collecting related papers for review from millions of publication records; 2) organizing these scientific papers according to their content; and 3) reducing the reading workload by generating a short summary of these studies. Using insights from the science of science studies, the AI-based knowledge distillation and paper production computing system 200 is capable of identifying the related references of a given topic and finding subtopics for these related papers. Clustering by the AI-based knowledge distillation and paper production computing system 200 of these selected paper further down based on their contents allows for a better composed and coherent flow for the paper. The BERT-based model processed by the AI-based knowledge distillation and paper production computing system 200 may be fine-tuned on citation context to produce summaries comparable to real ones written by experts.

Co-citation relation helps in collecting papers having similar topics easily and may require a seed paper which has to be chosen a user. In some cases, a seed paper may be automatically and/or randomly selected by the AI-based knowledge distillation and paper production computing system 200. Moreover, co-citation may not reflect fine-grained topics which becomes an obstacle to increase precision and recall. The AI-based knowledge distillation and paper production computing system 200 improve the recommendation system with an embedding method, which enable the AI-based knowledge distillation and paper production computing system 200 to find topically closer papers in an embedding space. For the clustering of papers into sections and organization within each section and subsection, the clustering engine 235 of the AI-based knowledge distillation and paper production computing system 200 may analyze the structure of full-text of review articles and learn the patterns of organization and their relation with publication date, citation counts, semantics of the contents as well cross-referencing relations among the candidate articles to be cited. In some cases, the AI-based knowledge distillation and paper production computing system 200 may be programmed to overcome the challenge of harmonizing of vastly different paper lengths, number of sections and references, and what portions of the papers take priority. Some decision may be subjective and, as such, a great deal of variation can be observed in full-text data (see, for example, FIG. 8). In some cases, the AI-based knowledge distillation and paper production computing system 200 may include a machine learning engine to process one or more machine learning algorithms to improve a subjective selection of information. In the summarization part, the AI-based knowledge distillation and paper production computing system 200 utilizes the rich information from citation context and builds a context-sensitive summarization model to capture the contribution of a paper from different perspectives. In doing so, the AI-based knowledge distillation and paper production computing system 200 facilitates and accelerates the process of scientific publication.

### Sample Summaries

A.1 Complex Networks

A.1.1 Keywords: Networks, Small-World, Network, Scale-Free, Properties, Systems, Webs, Power, Interactions, Complex.

Summary 1 Content:

Networks of coupled dynamical systems have been used to model biological oscillators, Josephson junction arrays, genetic control networks, which has been widely used to models of biological networks. [1] It has many advantages, among which to be inexpensive with only two fixed parameters with clear physical interpretation. the extended exponential family as a complement to the often used powers law distributions, which have many advantages: it has often been a simple and algebraic mechanism in terms of multiplicative processes [2] Numerous models of cellular metabolism to population dynamics have been carried out in the past two decades. [3] These models have been used to explore the role of susceptibility of the percolation and sand reserve models in order to provide susceptibility to these structures. [4] These approaches resulted in the detection of 957 putative interactions between 1,004 S. cerevisiae proteins in a biological context. [5] We characterize the coexistence of a local structure and the long-range connections of the network. we analyze the network properties of the small-world network models by Watts and Strogatz using Strogatz and Strogatz as well as numerical tools. in particular there exist a finite-temperature region which is a ferromagnetic phase transition as soon as the initial lattice is a [6]

### REFERENCES

[1] “Collective dynamics of ‘small-world’ networks”, Watts, DJ, Strogatz, SH, (1998)
[2] “Stretched exponential distributions in nature and economy: “fat tails” with characteristic scales”, Laherrere, J, Sornette, D, (1998)
[3] “Size and form in efficient transportation networks”, Banavar, JR, Maritan, A, Rinaldo, A, (1999)
[4] “Highly optimized tolerance: A mechanism for power laws in designed systems”, Carlson, J M, Doyle, J, (1999)
[5] “A comprehensive analysis of protein-protein interactions in Saccharomyces cerevisiae”, Uetz, P, Giot, L, Cagney, G, Mansfield, TA, Judson, R S, Knight, JR, Lockshon, D, Narayan, V, Srinivasan, M, Pochart, P, Qureshi-Emili, A, Li, Y, Godwin, B, Conover, D, Kalbfleisch, T, Vijayadamodar, G, Yang, MJ, Johnston, M, Fields, S, Rothberg, J M, (2000)
[6] “On the properties of small-world network models”, Barrat, A, Weigt, M, (2000)

### Summary 2 Content:

The time scales for the appearance of an autocatalytic set in the network have a power law dependence on the activity of the exponents of the exponent on the growth period. the exponents for the growth of a model of the expository tree. for the definition of the catalytic interactions among the populations of the species, the expo [1] These scaling exponents are often used to estimate the scaling properties of the scaling exponents of the connectivities of the model. in fact, the scaling property can be used to account for the observed power-law distribution of the connectivities of the nodes. we also use this to calculate the scaling exponent [2] A common property of many large networks is that the exponents of these large networks can be viewed as networks with complex topology. [3] We want to explore the behavior of the small-world network model, which mimics the transition between regular-lattice and random-lattice behavior in social networks of increasing size. [4] On the other hand, the regular oscillations in the average activity of the network are not in accordance with the lack of regular oscillations. [5] The mean-field solution of the model is exact in the limit of the large system size and for the distribution of path lengths in the model. [6]

### REFERENCES

[1] “Autocatalytic sets and the growth of complexity in an evolutionary model”, Jain, S, Krishna, S, (1998)
[2] “Mean-field theory for scale-free random networks”, Barabasi, A L, Albert, R, Jeong, H, (1999)
[3] “Emergence of scaling in random networks”, Barabasi, A L, Albert, R, (1999)
[4] “Renormalization group analysis of the small-world network model”, Newman, MEJ, Watts, DJ, (1999)
[5] “Fast response and temporal coherent oscillations in small-worldnetworks”, Lago-Fernandez, LF, Huerta, R, Corbacho, F, Siguenza, JA, (2000)
[6] “Mean-field solution of the small-world network model”, Newman, MEJ, Moore, C, Watts, DJ, (2000)

One or more aspects discussed herein can be embodied in computer-usable or readable data and/or computer-executable instructions, such as in one or more program modules, executed by one or more computers or other devices as described herein. Generally, program modules include routines, programs, objects, components, data structures, and the like, that perform particular tasks or implement particular abstract data types when executed by a processor in a computer or other device. The modules can be written in a source code programming language that is subsequently compiled for execution, or can be written in a scripting language such as (but not limited to) HTML or XML. The computer executable instructions can be stored on a computer readable medium such as a hard disk, optical disk, removable storage media, solid-state memory, RAM, and the like. As will be appreciated by one of skill in the art, the functionality of the program modules can be combined or distributed as desired in various embodiments. In addition, the functionality can be embodied in whole or in part in firmware or hardware equivalents such as integrated circuits, field programmable gate arrays (FPGA), and the like. Particular data structures can be used to more effectively implement one or more aspects discussed herein, and such data structures are contemplated within the scope of computer executable instructions and computer-usable data described herein. Various aspects discussed herein can be embodied as a method, a computing device, a system, and/or a computer program product.

Although the present invention has been described in certain specific aspects, many additional modifications and variations would be apparent to those skilled in the art. In particular, any of the various processes described above can be performed in alternative sequences and/or in parallel (on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive.

What is claimed is:

1. A computer-implemented method for summarizing research papers, comprising:
obtaining seed data indicating a reference paper;
determining a set of related papers based on the seed data, wherein each paper in the set of related papers comprises an abstract;
generating, using a machine learning models, summary data for the abstract of each paper in the set of related papers;
generating one or more content sections based on the summary data for each paper in the set of related papers, wherein each content section comprises an arrangement of the summary data of the set of related papers determined based on co-citations with the reference paper; and
generating a summary paper comprising the one or more content section.

2. The computer-implemented method of claim 1, wherein the machine learning model comprises a transformer architecture.

3. The computer-implemented method of claim 1, wherein the one or more content sections are determined using a principal component analysis.

4. The computer-implemented method of claim 3, wherein the one or more content sections comprise a cluster of research papers in the set of related papers determined using k-means clustering.

5. The computer-implemented method of claim 1, further comprising determining the one or more content sections based on one or more science of science measures.

6. The computer-implemented method of claim 1, wherein the set of related papers is determined based on topic similarity with a topic indicated in the seed data.

7. The computer-implemented method of claim 1, wherein the summary data comprises a human-readable set of statements.

8. A computing device for summarizing research papers, comprising:
a processor; and
a memory in communication with the processor and storing instructions that, when read by the processor, cause the computing device to:
obtain seed data indicating a reference paper;
determine a set of related papers based on the seed data, wherein each paper in the set of related papers comprises an abstract;
generate, using a machine learning model, summary data for the abstract of each paper in the set of related papers;
determine one or more content sections based on the summary data for each paper in the set of related papers, wherein each content section comprises an arrangement of a portion of the set of related papers determined based on co-citations with the reference paper; and
generate a summary paper comprising the one or more content section.

9. The computing device of claim 8, wherein the machine learning model comprises a transformer architecture.

10. The computing device of claim 8, wherein the one or more content sections are determined using a clustering algorithm.

11. The computing device of claim 10, wherein the one or more content sections comprise a cluster of research papers in the set of related papers determined using k-means clustering.

12. The computing device of claim 8, wherein the instructions further cause the computing device to determine the one or more content sections based on one or more science of science measures.

13. The computing device of claim 8, wherein the set of related papers is determined based on topic similarity with a topic indicated in the seed data.

14. The computing device of claim 8, wherein the summary data comprises a human-readable set of statements.

15. A non-transitory machine-readable medium storing instructions that, when executed by one or more processors, cause the one or more processors to perform steps comprising:
obtaining, by a machine classifier, seed data indicating a reference paper;
determining a set of related papers based on the seed data, wherein each paper in the set of related papers comprises an abstract;
generating, using a machine learning model, summary data for the abstract of each paper in the set of related papers;
determining one or more content sections based on the summary data for each paper in the set of related papers, wherein each content section comprises an arrangement of the summary data of the set of related papers determined based on co-citations with the reference paper; and
generating a summary paper comprising the one or more content section.

16. The non-transitory machine-readable medium of claim 15, wherein the machine classifier comprises a transformer architecture.

17. The non-transitory machine-readable medium of claim 15, wherein:
the one or more content sections are determined using a principal component analysis; and
the one or more content sections comprise a cluster of related papers in the set of research papers determined using k-means clustering.

18. The non-transitory machine-readable medium of claim 15, further comprising determining the one or more content sections based on one or more science of science measures.

19. The non-transitory machine-readable medium of claim 15, wherein the set of related papers is determined based on topic similarity with a topic indicated in the seed data.

20. The non-transitory machine-readable medium of claim 15, wherein the summary data comprises a human-readable set of statements.
